(19) United States
(12) Patent Application Publication
(10) Pub. No.: US 2004/0092152 A1
(43) Pub. Date: May 13, 2004

(54) ELECTRICAL CONNECTOR WITH DISTRIBUTION CONTACTS

(75) Inventor: Che-Chia Chang, Taipei (TW)

Correspondence Address: TROXELL LAW OFFICE PLLC, SUITE 1404, 5205 LEESBURG PIKE, FALLS CHURCH, VA, 22041, US

(73) Assignee: Comax Technology Inc.

(21) Appl. No.: 10/291,623

(22) Filed: Nov. 12, 2002

(51) Int. Cl. H01R 4/24

(52) U.S. Cl. 439/404

(57) ABSTRACT

The connector of the present invention comprises at least one contact plate or a plurality of contact plates, wherein one end of each contact plate has a plurality of terminals or pins and another end has a connection section. Because the pins carry the same voltage and are connected together, the total voltage or current capacity of the contact plate is increased. Since the terminals or pins are connected to form a contact plate, only one single wire is required to be connected to a contact plate that distributes the signal or voltage of the wire to a plurality of pins instead of a wire or jumper connecting to each of the desired pins as in the conventional method.

### BACKGROUND OF THE INVENTION

1. Field of the Invention

The present invention relates generally to an electrical connector. More particularly, the present invention relates to an electrical connector with distribution contacts.

2. Description of Related Art

Present-day society increasingly relies on computers, computer systems, computer software applications and computer devices as computers become more essential in everyday life. With the increasing demands of computer applications in various areas, the utility and usefulness of computers increase, and integrated circuit (IC) connection become more complex. Various techniques have been developed to increase the number of IC device connections while providing a more compact computer with high performance.

Device such as hard disk drives or CD-ROM drives or peripherals such as printers or external mass storage devices are connected to a host computer by cables, these cables have connectors and contacts attached to the wires in the cable.

There are common methods for connection wires to the pins of the connectors. However, these methods require considerable time and skill. For example, with some methods, during the process of attaching each wire to each pin, the temperature has to be controlled carefully so that the wire can be bonded to the pin strongly without overheating the wire. Other methods require considerable forces, and if too much force is applied, the cooper portion of the wire can be damaged or even break off. Additionally, each pin has to be connected to every wire in order to make the proper connection. In a 40 pins connector, for example, 40 individual wires need to be attached or connected to the connector contact. Therefore, making the connections is time consuming, resulting in an increased production cost.

As a result, an improved electrical connector that reduces production time, defects, and lower production costs is needed.

### SUMMARY OF THE INVENTION

It is an object of the present invention to provide a more compact, reliable and cost-effective connector by utilizing an improved connector with improved connection and contacts.

The previous example describes a one wire to one contact connecter where each contact is attached to only on wire. In some situations a wire or a plurality of wires must be connected to a plurality of contacts or pins of the connector. This can be accomplished by connection jumpers between the plurality of contacts. However, this increases the production time and increases the probability of a damaged or imperfect part.

As a result, an improved connector incorporating contacts that distribute a signal or voltage to a plurality of pins or contacts has been developed. Therefore a wire or a plurality of wires can be connected to a plurality of pins of the connectors without requiring jumpers to make the connection.

Both the foregoing general description and the following detailed description are exemplary and explanatory only and are not restrictive of the invention, as claimed.

### BRIEF DESCRIPTION OF THE DRAWINGS

The present invention can be more fully understood by reference of the following description and accompanying drawings, in which:

FIG. 1 is an assembly view showing a connector with distribution contacts in accordance with an embodiment of the present invention;

FIG. 2 is an assembly view of another cover in accordance with an embodiment of the present invention;

FIG. 3 is an assembly view of the other cover in accordance with an embodiment of the present invention;

FIG. 4 is an assembly view of yet the other cover in accordance with an embodiment of the present invention;

FIG. 5 is a drawing showing a contact plate of a connector in accordance with an embodiment of the present invention;

FIG. 6 is a magnified view showing a portion of a contact plate shown in FIG. 5, in accordance with an embodiment of the present invention;

FIG. 7 is a drawing showing a distribution contact plate of a connector in accordance with an embodiment of the present invention;

FIG. 8 is a drawing showing a solder-able contact plate of a connector in accordance with an embodiment of the present invention;

FIG. 9 is a drawing showing a crimp-able contact plate of a connector in accordance with an embodiment of the present invention;

FIG. 10 is an assembly view showing a connector with distribution contacts in accordance with an alternative embodiment of the present invention; and

FIG. 11a and 11b is a lateral view showing a contact plate of a connector in accordance with an alternative embodiment of the present invention.

### DETAILED DESCRIPTION OF THE PREFERRED EMBODIMENTS

It is an object of the present invention to provide a more compact, reliable and cost-effective connector by utilizing a connector with improved connections and contacts allowing a wire or wires to be electrically connected to a plurality of contact pins or points.

The previous example describes a one wire to one contact connector where each contact is attached to only one wire. In some situations a wire or a plurality of wires must be connected to a plurality of contacts or pins of the connector. This can be accomplished by connection jumpers between the plurality of contacts. However, this increases the production time and increases the probability of a damaged or imperfect part.

As a result, an improved connector incorporating contacts that distribute a signal or voltage to a plurality of pins or contacts has been developed. Therefore a wire or a plurality of wires can be connected to a plurality of pins of the connectors without requiring jumpers to make the connection.

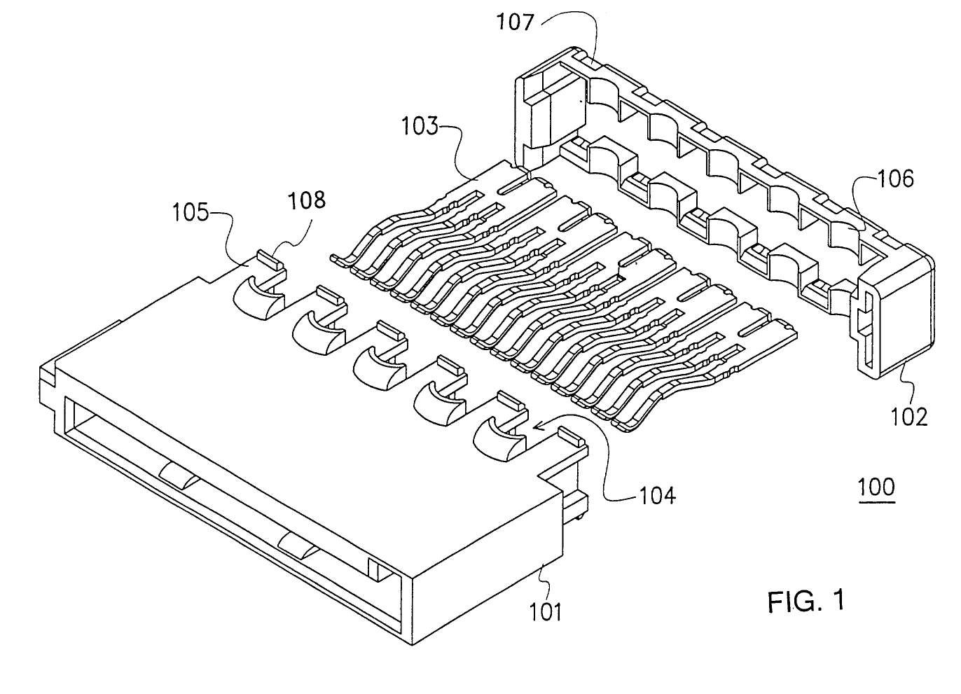

Referring to FIG. 1, which illustrates an assembly view of a connector in accordance with an embodiment of the present invention. A connector 100 comprises: a housing 101, a cover 102 and a contact plate 103. A housing 101 has a plurality of slots 104 that are used to insert wires into and a plurality of first protrusions 105, and having a protrusion portion 108 on the first protrusions 105. The first protrusions 105 are arranged in such a way so as to be separated from each other by the slots 104 to form a finger-like structure. A cover 102 is disposed on one side of the housing 101, both side of the housing 101 have a fastener structure that constitute with the protrusions 108 of the housing 101 and a plurality of concave surfaces 106. Location of the concave surfaces 106 of the cover 102 are matched and correspond to positions of the slots 104 of the housing 101. The housing 101, cover 102, 102a, 102b, 102c and contact plate 103 are examples and do not limit the housing 101, cover 102, 102a, 102b, 102c and contact plate 103 of the present invention to those types shown. Various other types of housing 101, cover 102, 102a, 102b and 102c are also envisioned depending on the size and number of pins required.

During an integrating process, at least one contact plate 103 is inserted into the housing 101, and the cover 102 is integrated onto a part of the housing 101. For example purpose, FIG. 1 shows five contact plates 103 but the numbers of contact plates 103 can be increased or decreased as determined by the number of contact plates 103 required by the connector.

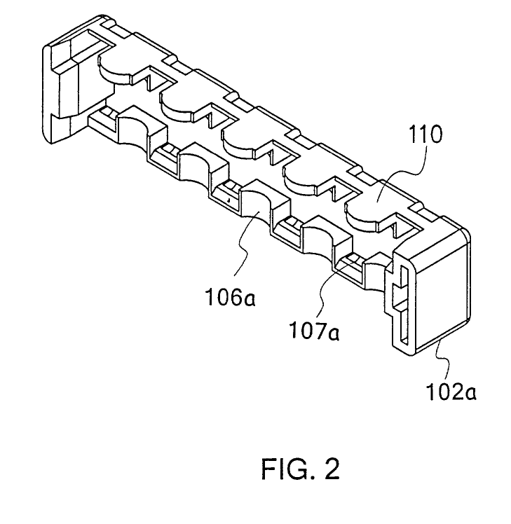

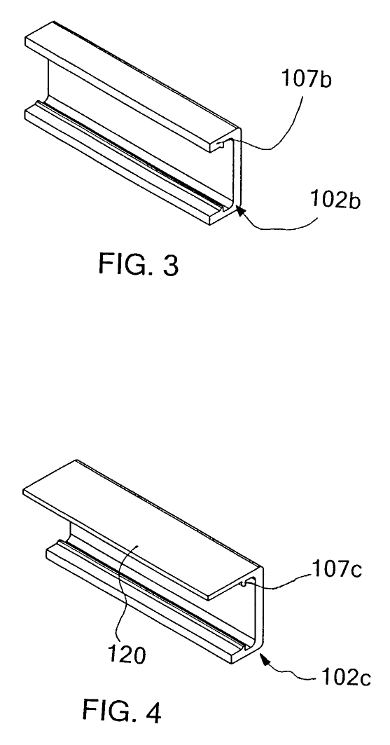

Referring to FIG. 2, which illustrates an assembly view of another cover in accordance with an embodiment of the present invention. As shown in FIG. 2, the concave surfaces 106 of the cover 102 (shown in FIG. 1) have been replaced by a plurality of second protrusion structure 110 (shown in FIG. 2). Locations of the plurality of second protrusion structure 110 of cover 102a are matched and correspond to the positions of the slots structure of the housing 101, the shapes of the second protrusion structure 110 and the shapes of the slots structure are matched each other. Please refer to FIG. 3, two sides of the cover 102b can only be placed a fastener structure 107b as required without the concave surfaces 106 of the cover 102 (shown in FIG. 1), in order to make the cover 102 engage to the protrusion portion 108 of the housing 101 directly, additionally, Please refer to FIG. 4, two sides of the cover 102c can be placed a fastener structure 107c as required, and one side of the cover 102c can be placed a blocking plate 120 that can shield the slots structure 104 of the housing 101.

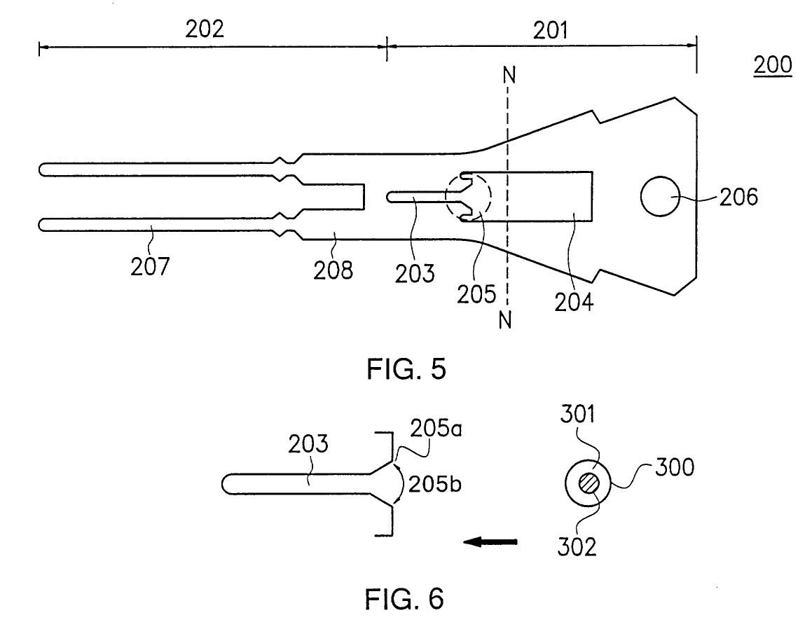

FIG. 5 is a drawing showing a contact plate of a connector in accordance with an embodiment of the present invention. Referring to FIG. 5, the contact plate 200 comprises a top portion 201 and a forked portion 202.

The top portion 201 comprises an oblong-shaped slot, which is an insulation displacement contact (IDC) section 203 extending into a wider hole 204 via a Y-shaped transition portion 205. The circular hole 206 is for positioning the contact plate during a fabrication process. In an integrating process, the top portion 201 will be broken off along a line N-N.

A standard insulated wire can be inserted into the IDC section 203. The wire is inserted through the Y-shaped transition portion 205 into the IDC section 203.

FIG. 6 illustrates a magnified view showing a portion of the contact plate according to an embodiment of the present invention. Referring to FIG. 6, The Y-shaped transition portion 205 comprises a pair of sharp edges 205a and a Y-shaped opening 205b. A distance between the sharp edges 205a is smaller than an outer diameter of the conductive wire portion 302 contained in the wire 300. When the wire 300 is inserted into the Y-shaped opening 205b, the sharp edges 205a will cut through an insulating portion 301 of the wire 300, and a conductive wire portion 302 of the wire 300 is exposed and comes into contact with the IDC section. The Y-shaped transition portion 205 is designed in such way that it allows the wire to electrically connect to the terminals without soldering or crimping and without any damage to the conductive wire portion 302 of the wire 300.

Referring again to FIG. 5, the forked portion 202 of the contact plate 203 comprises two conducting terminals, pins or leads 207, which are connected at one end into a contact part 208, thus forming a fork-shaped structure. The conductive terminals, pins or leads 207, can be made of, for example, cooper alloy for good conductivity.

After the wire is connected to the contact plate, any signal or voltage level that pass through the wire, is distributed to a plurality of contact pins or terminals of the connector. In this way, a wire or a plurality of wires can be connected to a plurality of pins of the connector without requiring jumpers to make the multiple connections. In the conventional method a wire is attached to a first contact. Then one end of a jumper is connected to the wire or first contact. Finally, the other end of the jumper is connected to the second contact. This requires 3 connecting steps during the manufacturing process. However, with the present invention, only one connection is required where the wire is connected to the contact pad and the contact pad distributes the signal to the appropriate contact terminals or pins.

The connector of the present invention comprises at least one contact plate or a plurality of contact plates, wherein one end of each contact plate has a plurality of terminals or pins, such as two pins, for example, and another end has a connection section. Each pin can carry a signal, current or voltage, for example 3V, 5V, or 12V. The pins that carry the same signal, current or voltage are then combined together into one contact plate. Because the pins carry the same voltage and are connected together, the total voltage or current capacity of the contact plate is increased. Since the pins are connected to form a contact plate, only one signal wire is required to connected to a contact plate inserted of every wire connection to every pin as in the conventional method. Therefore, the number of wire connections is reduced.

The contact plate of the present invention is not limited to the number of conducting forked structures in each contact plate. Also, the number of contact plates can be combined into more two conducting structures.

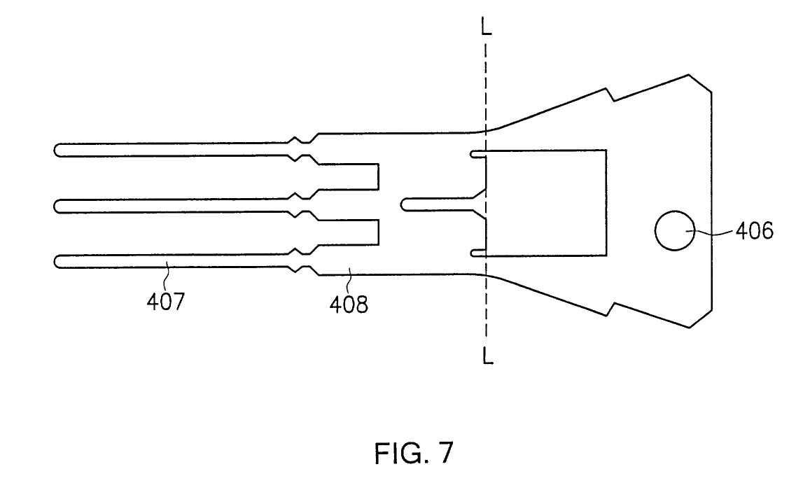

FIG. 7 illustrates a contact plate of a connector with distribution contact in accordance with an embodiment of the present invention. Based on the same principles and theory, a contact plate comprises three terminals or pins 407 are shown. The number of terminals or pins can be any quantity and is not limited to two or three as shown in the drawings. In fact, as shown above, increasing the number of terminals or pins increases the value of the present invention. The present invention only requires one connection per contact pin in order to distribute a signal or voltage to a plurality of pins. However, with the conventional method, if a signal is to be sent to four pins a total of seven connections are required.

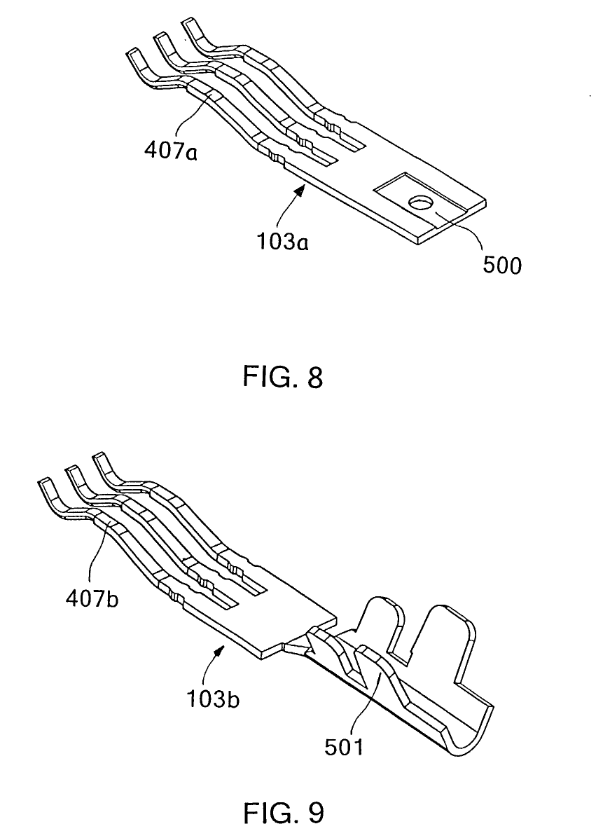

In previous embodiments, connections between the wire or a plurality of wires and pins or terminals are made by IDC method. However, in other embodiments of the present invention, the IDC method can be implemented by soldering, crimping or other connection methods. Two possible methods are shown in FIG. 8 and FIG. 9. Please refer to FIG. 8, which illustrates a structure view of a solder-able contact plate in accordance with an embodiment of the present invention. The contact plate 103a has a soldering portion 500 located at an opposite end of the pin 407a, wherein a wire or a plurality of wires can be soldered to the soldering portion 500 of the contact plate 103a. Please refer to FIG. 9, which illustrates a structure view of a crimp-able contact plate in accordance with an embodiment of the present invention. The contact plate 103b has a crimping portion 501 located at an opposite end of the pin 407b, wherein a wire or a plurality of wires can be connected to the crimping portion 501 of the contact plate 103b by crimping method

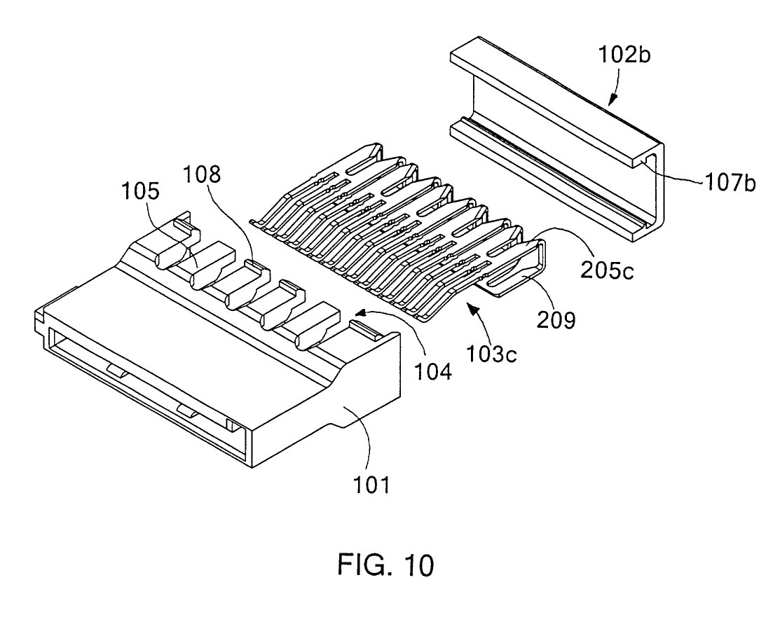

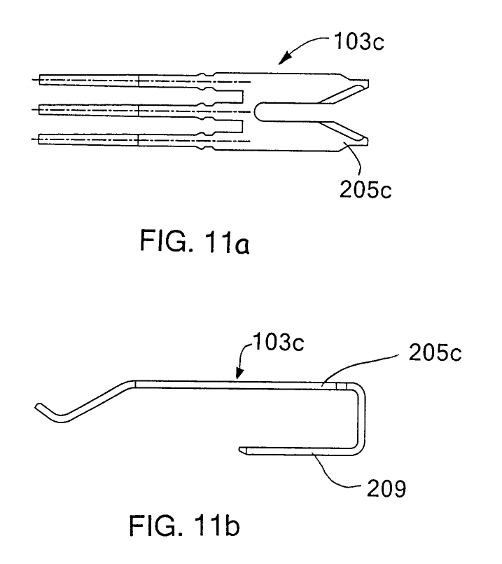

Additionally, in order to improve the performance of the electrically connect of the contact plate and wire, please refer to FIG. 10, FIG. 11a and 11b, wherein the free end of the first Y-shaped transition portion 205c of the contact plate 103c is extended and folded back such that to generate a second Y-shaped transition portion 209 that parallel to the first Y-shaped transition portion 205c. As a result, increasing the contact area of the wires that are inserted into, and ensuring the electrically connect of the contact plate 103c and wires.

Advantages of the present invention are at least:

1. The number of connections that are required is reduced, therefore, less time is required and the cost is reduced.

2. The total voltage or current capacity of the contact plate is greatly increased.

3. The connection between wires or pins or wires to wires is more effective and rapid no damage occurs to the conductive portion of the wire.

4. The cost of production is significantly reduced, and the integrating process and fabrication process are simplified.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A electrical connector with distribution pin or pins, wherein the connector is connected to a wire or wires in order to form a electrically channel, at least comprising:
a housing having a plurality of first protrusions on one end, wherein the first protrusions are separated from each other by a plurality of slots, and the plurality of first protrusions have a plurality of protrusion portions;
at least one contact plate, which is positioned in the housing, wherein one end of the contact plate is formed a fork-shaped pin, and another end of the contact plate has a first Y-shaped transition portion which as an insulation displacement contact connects to the wire or wires;
a cover is disposed on one side of the housing, wherein both sides of the cover have a fastener structure that constitute with the protrusion portion.

2. The connector of claim 1, wherein the electrically connect between the wire and the contact plate is made by soldering method, and the contact plate has a soldering portion located at an opposite end of the pin.

3. The connector of claim 1, wherein the electrically connect between the wire and the contact plate is made by crimping method, and the contact plate has a crimping portion located at an opposite end of the pin.

4. The connector of claim 1, wherein the material of the contact plate comprises cooper alloy.

5. The connector of claim 1, wherein both sides of the cover have a plurality of concave surfaces that are used for inserting the wires into, and the plurality of concave surfaces match positions of the slots, wherein the cover is fit onto the housing.

6. The connector of claim 1, wherein one side of the cover has a plurality of concave surfaces that are used for inserting the wires into, and another side of the cover has a second protrusion structure for shielding the wire, wherein the cover is fit onto the housing.

7. The connector of claim 1, wherein one side of the cover has a blocking plate for shielding the wire.

8. The connector of claim 1, wherein a free end of the first Y-shaped transition portion of the contact plate is extended and folded back such that to generate a second Y-shaped transition portion that parallel to the first Y-shaped transition portion for improving the electrically connect of the wire.
